(19) United States
(12) Patent Application Publication
(10) Pub. No.: US 2019/0200736 A1
(43) Pub. Date: Jul. 4, 2019

(54) Multi-rotor helicopter straps for backpacks

(71) Applicant: Thomas Tong, Santa Cruz, CA (US)

(72) Inventor: Thomas Tong, Santa Cruz, CA (US)

(21) Appl. No.: 15/861,475

(22) Filed: Jan. 3, 2018

(51) Int. Cl. A45F 3/14; A45F 3/04; A45F 5/02

(52) U.S. Cl. CPC A45F 3/14; B64C 27/08; A45F 5/02; A45F 3/04

(57) ABSTRACT

Strapping system to enable any ordinary backpack to become a drone carrier.

### BACKGROUND OF INVENTION

This invention was born out of my need to transport my drone(s) without the need for bulky carrying cases offered in the current market. These commercially available cases are both expensive ($100 or more) and very bulkly. Not only that, they usually are designed to house only the drone and the accessories, thereof.

I needed a simpler way to transport my drone and to also engage in my activities without shouldering a huge transport case. I felt I should be able to go biking or hiking (or any other outdoor activity without looking like an overburdened burro). I had many packpacks around the house, and wanted to use them. But some drones simply do not fit well inside a standard backpack (see FIG. 4).

### BRIEF SUMMARY OF THE INVENTION

The primary object of this invention allows using an existing packpack made for normal use, such as packing items for activities like hiking, biking, skiing, skating or simply walking, to be used as a drone carrier.

A further object of the invention is to allow for quick attachment and detachment of the drone from the backpack.

Another object of the invention is to make the drone secure for transport and prevent unplanned detachment from the packback.

A further object of the invention is to allow an existing backpack to become a drone carrier fairly inexpensively, compared to purchasing a dedicated carrier.

These objects and advantages of the invention will be readily understood by reading the following descriptions in conjunction with the accompanying drawings. Reference numbers have been applied to indicate the various elements of the invention.

### BRIEF DESCRIPTION OF THE DRAWINGS

FIG. 1A is a view of top strap with male buckle end

FIG. 1B is a view of top strap with female buckle end

FIG. 2 is a view of the bottom strap, buckled

FIG. 3A is a view of a slim paracord lock

FIG. 3B is a view of a cylindrical paracord lock

FIG. 3C is a view of a round paracord lock

FIG. 3D is a view of a slider-locking paracord lock

FIG. 4A is a side view of a typical commercially available backpack

FIG. 4B is a front view of a typical commercially available backpack

FIG. 5 is a view of a drone attached to the backpack using the strapping invention

### DESCRIPTION OF THE PREFERRED EMBODIMENTS

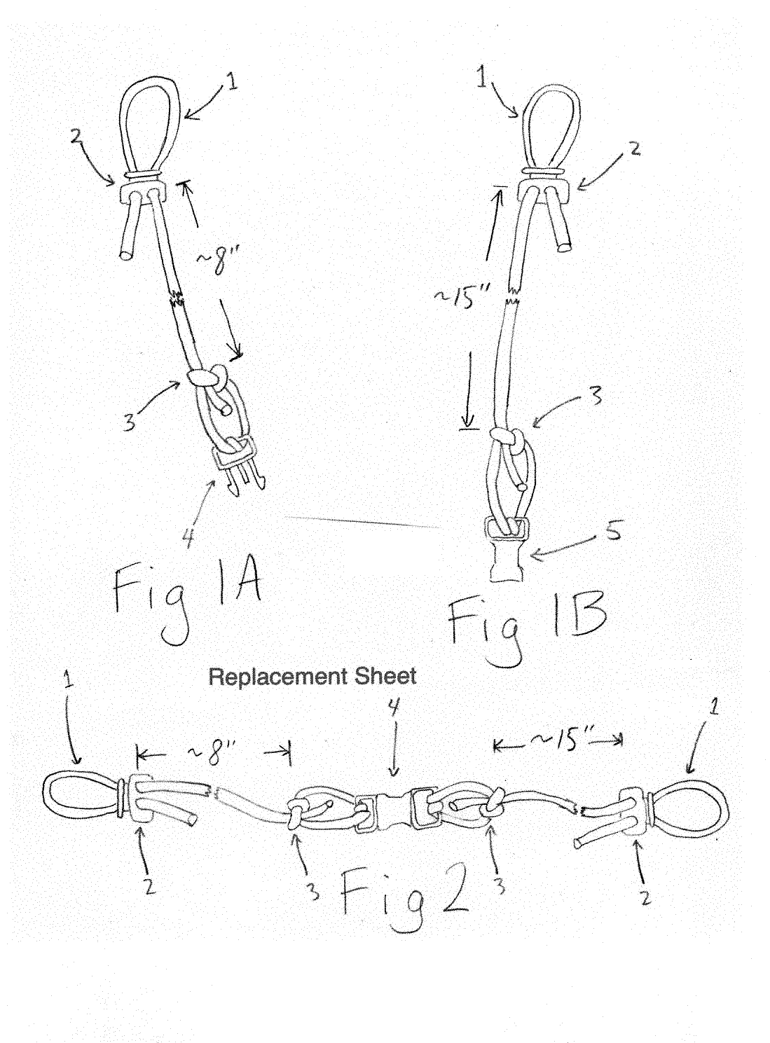

In FIG. 1A and FIG. 1B, shows the upper strap is shown in its unbuckled state. The paracord 1 is looped through the paracord lock 2. The length of the paracord is looped around the buckles ends (4—male end, 5—female end) and tied in a bowline knot 3.

In FIG. 2, the lower strap with the same identification as FIG. 1 with the buckle ends snapped together 4.

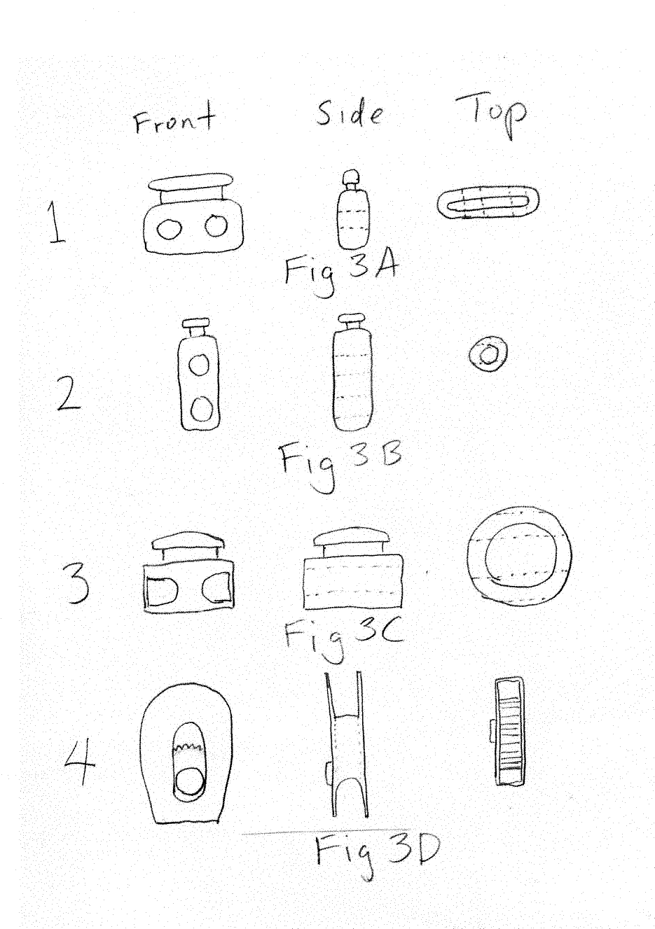

In FIG. 3A through FIG. 3D, four different paracord locks are depicted, flat 1, cylindrical 2, round 3, and slide locking 4 versions. Front, side and top views are supplied for each type.

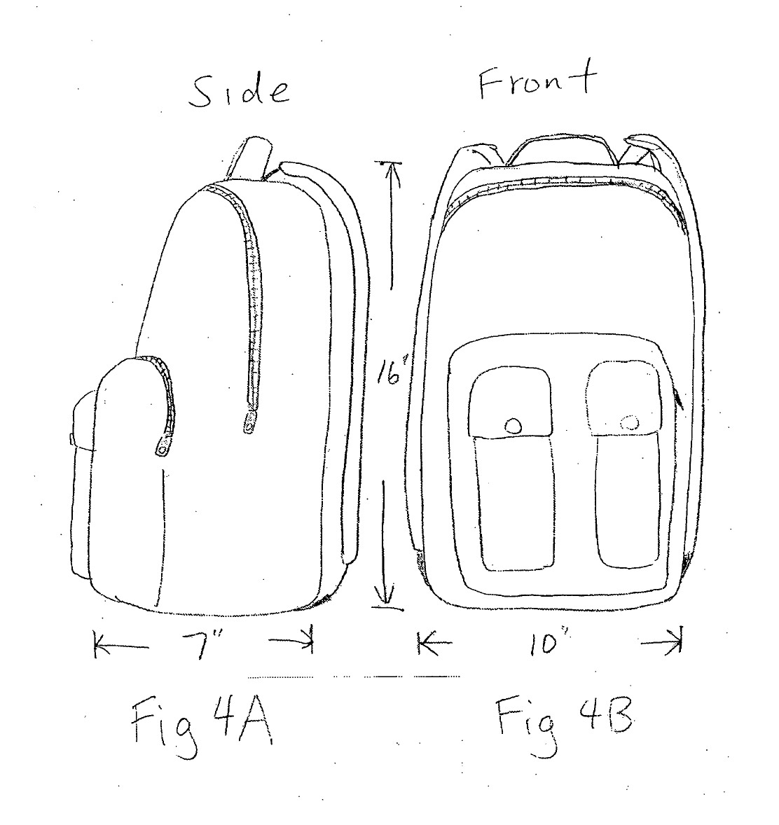

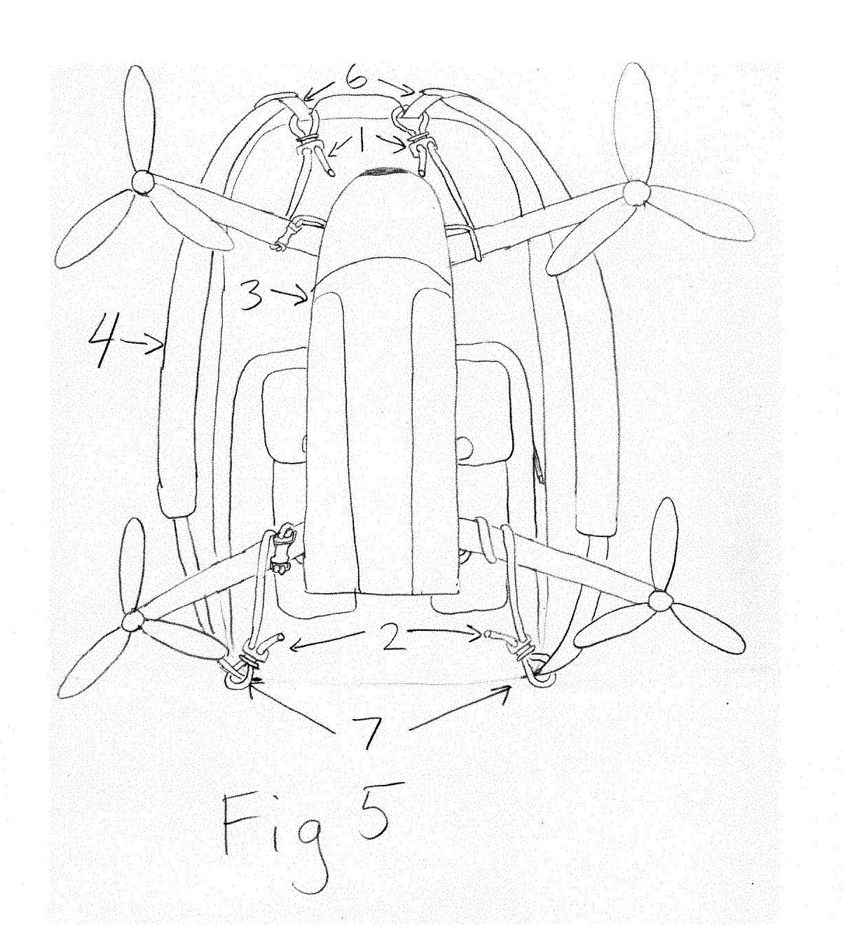

In FIG. 4A and FIG. 4B, shows a typical backpack and its dimensions are depicted.

In FIG. 5, a drone 3 is attached to a typical packpack 4 using the strap mechanism (1, 2). The straps are attached to the backpack's top shoulder strap/handle 6, and to the shoulder straps' lower attachment to the backpack 7.

The paracord or 550 cord when referring to a type-III paracord, is used for the main strapping material. The difference in length of the two half of each strap (top and bottom) allows for the buckling to occur off-center, reducing the chances of scratching the drone. Nylon straps can also be substituted for the paracord.

What is claimed is:

1: A tie down mechanism for implementing a drone carrying capability for backpacks, comprising two straps which are secured to the shoulder straps of the backpack. Each strap is fitted with a buckle and cord lock on each end. One strap is secured to the top mounting points of the shoulder straps, and the other strap is secured to the bottom mounting points of the shoulder straps. A drone is placed on the front of the backpack, with the top strap wrapping around the top legs and body of the drone, and the bottom strap wrapping around the bottom legs and the body of the drone, securing the drone to the backpack. The strap length should be adjusted such that the drone is fitted properly, allowing the user to wear the backpack in the usual manner whilst transporting the drone safely using the mechanism.

2: The mechanism of claim 1, wherein the straps are formed of cord made of synthetic material such as nylon paracord.

3: The mechanism of claim 1, in which the cord lock is any locking device which may lock or loosen around the cord loop depending on whether a button is manipulated up or down or pressed by the user.

4: The mechanism of claim 1, in which the buckle allows the strap to be tied to each end of the buckle and the buckle allows for secure latching of the complimentary halves of the strap.

5: The mechanism of claim 1, wherein both cord is fastened to complimentary halves of the buckle on either end, after the user have threaded the cord around the legs and body of the drone.

6: The mechanism of claim 1, the cord is fastened to the top mounting points of the shoulder straps by looping one end the cord around either shoulder strap and using the cord lock to secure it in place, and doing the same with the other end.

7: The mechanism of claim 1, the cord is fastened to the bottom mounting points of the shoulder straps by looping one end the cord around either shoulder strap and using the cord lock to secure it in place, and doing the same with the other end.

8: The mechanism of claim 1, the top and bottom cords shall of of sufficient length to accommodate the wrapping around the legs and body of the drone while secured to the shoulder straps.

9: The mechanism of claim 1, the top and bottom cords shall have nominal extra lengths to allow for adjustments due to size of drone and backpack.
